(19) United States
(12) Patent Application Publication
(10) Pub. No.: US 2010/0214192 A1
(43) Pub. Date: Aug. 26, 2010

(54) DIRECTIONAL DIGITAL TV ANTENNA

(76) Inventor: ALBERT CHAO, Saddle River, NJ (US)

Correspondence Address: NOTARO, MICHALOS & ZACCARIA P.C., 100 DUTCH HILL ROAD, ORANGEBURG, NY, 10962, US

(21) Appl. No.: 12/391,567

(22) Filed: Feb. 24, 2009

(51) Int. Cl. H01Q 1/50

(52) U.S. Cl. 343/906

(57) ABSTRACT

A directional antenna captures digital signals from the air and has a base with a first coaxial connector and central electrical and mechanical contact surface at an axis of rotation as well as an annular electrical and mechanical contact surface extending around the axis. A coaxial cable has a core conductor connected to the central contact surface and an outer shielding conductor connected to the annular contact surface. A device connector is connected to an opposite end of the core and shielding conductors for connecting the cable to a device such as a TV. A substrate mounted for rotation to the base about the axis of rotation has a support surface for a pair of conductive sheets. A second coaxial connector is connected to the substrate and has a central electrical and mechanical contact surface at the axis of rotation and an annular electrical and mechanical contact surface extending around the axis of rotation. The contact surfaces of the first and second connectors are engaged for sliding electrical and mechanical contact so the substrate can rotate.

### FIELD AND BACKGROUND OF THE INVENTION

The present invention relates generally to the field of antennas, and in particular to a new and useful directional digital TV antenna that has a pair of signal receiving conductive sheets that are mounted on a rotatable nonconductive substrate.

A wide variety of TV antennas are known but all, especially those that have directional qualities, are complicated, often require power, and are generally large elongated structures.

The directional nature of digital TV signals in particular, has become increasingly important since the planned or instituted exclusive use of digital transition for all U.S. TV broadcasts in 2009. See http://www.antennaweb.org/aw/Address.aspx for a website that gives the direction and strength for receiving a signal, and the type of antenna that is recommended for all TV broadcasters that are likely to be received at any particular address in the U.S.

There is a need for an inexpensive and effective directional digital TV antenna.

### SUMMARY OF THE INVENTION

It is an object of the present invention to provide a digital TV antenna that is small, passive (i.e. unpowered) and simple, while being very efficient at picking up digital TV signals that are typically in the frequency range of 470 to 860 MHz.

It is also an object of the invention to provide an antenna for capturing digital signals from the air, comprising: a base for establishing a fixed frame of reference, the base defining an axis of rotation; a first coaxial connector connected to the base and having a central electrical and mechanical contact surface at the axis of rotation and an annular electrical and mechanical contact surface extending around the axis of rotation; a coaxial cable having a core conductor electrically connected at one end to the central contact surface and an outer shielding conductor electrically connected at the one end to the annular contact surface; a device connector electrically connected to an opposite end of the core and shielding conductors for connecting the coaxial cable to a device for receiving digital signals from the antenna; a substrate mounted for rotation about the axis of rotation to the base, the substrate having a support surface extending outwardly from and around the axis of rotation; a second coaxial connector connected to the substrate and having a central electrical and mechanical contact surface at the axis of rotation and an annular electrical and mechanical contact surface extending around the axis of rotation, the central contact surfaces of the first and second connectors being engaged with each other for sliding electrical and mechanical contact, and the annular contact surfaces of the first and second connectors being engaged with each other for sliding electrical and mechanical contact, so that as the substrate rotates with respect to the base, digital signals pass from the second to the first connectors and to the coaxial cable conductors; and a pair of signal receiving conductive sheets fixed to the support surface of the substrate, and spaced from each other along a diametric line on the support surface that passes through the axis of rotation, the central contact surface of the second coaxial connector being connected to one of the conductive sheets and the annular surface of the second coaxial connector being connected to the other conductive sheet, each conductive sheet occupying at least 40% of a full semicircular area on one side of the diametric line so that the conductive sheets together absorb digital signals from the air in a directional manner.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective exploded view of a preferred embodiment of the invention;

FIG. 2 is a perspective view of the top or upper surface of a substrate of the embodiment of FIG. 1;

FIG. 3 is an enlarged sectional view of the rotary connection between the substrate and a base of the embodiment of FIG. 1;

FIG. 4 is a perspective bottom view of the assembled antenna of the invention; and

FIG. 5 is a top plan view of another embodiment of the invention.

### DESCRIPTION OF THE PREFERRED EMBODIMENTS

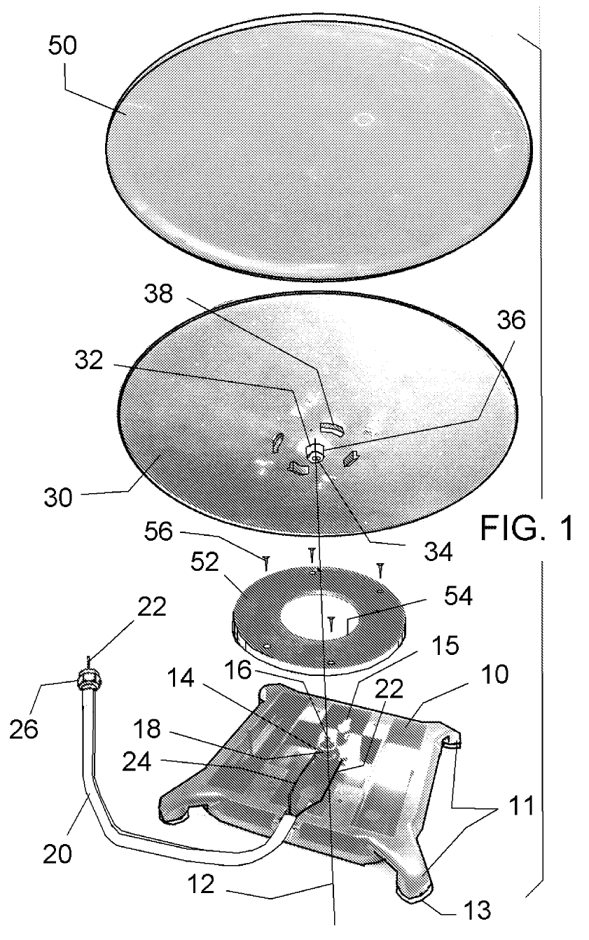

Referring now to the drawings, in which like reference numerals are used to refer to the same or similar elements, FIG. 1 shows a directional digital antenna for capturing digital signals from the air, comprising a base 10 for establishing a fixed frame of reference on a work surface such as a TV stand or on a wall near the TV. While suited in particular for use with a digital televison set, the antenna of the invention can be used to capture digital signals for any device that can process such signals.

Base 10 also defines an axis of rotation 12. Referring also to FIG. 3, a first coaxial connector 14 is centrally mounted to the base 10 and has a central electrical and mechanical contact surface or post 16 at the axis of rotation 12. Connector 14 is advantageously the male part of a standard RCA connector. Connector 14 also has an annular electrical and mechanical contact surface 18 extending around the axis of rotation 12 and the central contact surface 16. A coaxial cable 20 having one end extending into the base 10, includes a core conductor 22 (e.g. of solid copper) electrically connected at one end to the central contact surface 16, e.g. by soldering, and an outer shielding, e.g. braided conductor 24 electrically connected at the one end to the annular contact surface 18, also, for example, by soldering.

A device connector 26 is connected at the opposite end of cable 20. Connector 26 is advantageously a standard F type or RG6 coaxial connector of the type that is typically used for connecting to the threaded coaxial input plug of a television set. Connector 26 is electrically connected to, or receives the exposed opposite end of the core conductor 22 and shielding conductor 24, for connecting the coaxial cable to a device for receiving digital signals from the antenna, such as a TV set.

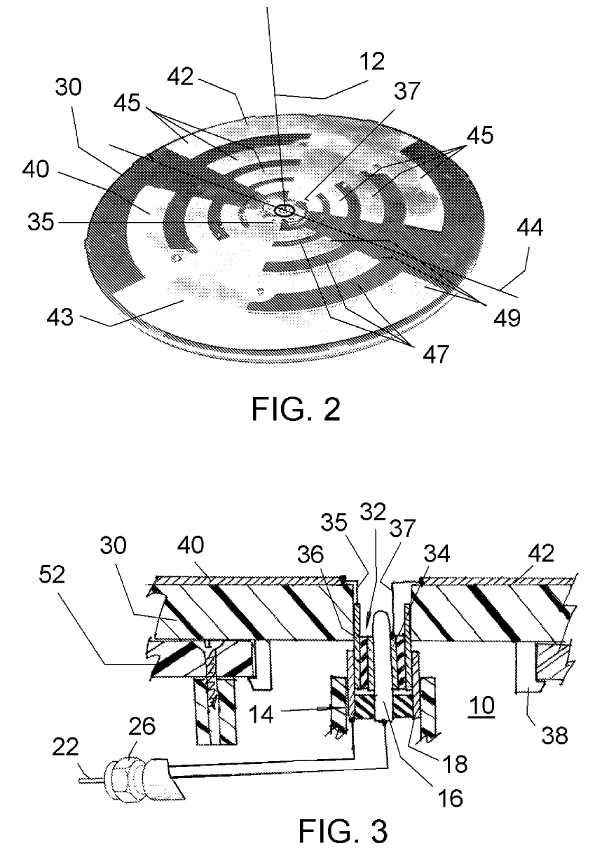

An electrically insulating and self supporting substrate 30 is mounted for rotation about the axis of rotation 12, to the base 10. In FIG. 1, the bottom surface of the substrate 30 is visible. The substrate 30 is made, for example, of plastic a has an upper support surface visible in FIG. 2, extending outwardly from, and extending around the axis of rotation 12.

A second coaxial connector 32, e.g. the female part of a standard RCA connector, is connected to the center of the substrate 30 and has a central electrical and mechanical contact surface 34 at the axis of rotation 12, and an annular electrical and mechanical contact surface 36 extending around the axis of rotation. When the male and female, respective first and second connectors 14 and 32 are plugged to each other as in FIG. 3, the central contact surfaces 16 and 34 of the first and second connectors 14 and 32, are engaged with each other for sliding electrical and mechanical contact, and the annular contact surfaces 18 and 36 of the connectors are engaged with each other for sliding electrical and mechanical contact. In this way, when the connectors 14 and 32 are pugged to each other, the substrate 30 can rotate with respect to the base 10, while a digital signal can still pass from the second to the first connectors, to the coaxial cable conductors 22 and 24 and the plug 26, to the device, e.g. a TV, to which the plug 26 is connected.

The RCA connector made up of the male and female jacks or connectors 14 and 32, is also referred to as a phono connector or Cinch connector. Connection is made by pushing the male and female jacks together and because of the rotational symmetry of the matting parts of an RCA connector pair, the male and female parts of the RCA connector can rotate with respect to each other while maintaining electrical and mechanical contact. This capacity, to the knowledge of the inventor, has not been exploited before, but makes this type of connector particularly valuable for use as a central mounting for the rotatable parts of the antenna of the present invention.

Unexpectedly and advantageously, the usual frictional engagement between the rotationally symmetrical contacts 16/34 and 18/36 of the RCA connectors 14/32, maintains electrical contact without requiring conducive rings and brushes as are usually uses for transmitting electrical signals from one rotatable part to another, and, at the same time, provides a satisfying resistance to the rotation that is perceived by the user as he or she manually rotates the substrate 30 in the base 10, to prevent any free spinning of the substrate. The inventor has found that for the best reception, it is often necessary to slowly rotate the substrate only a few degrees at a time. The resistance to rotation that is automatically introduced by using mated RCA connects that are not designed for such rotation but can accommodate it, allows the user to feel that the substrate will stay in the rotational position he or she moves it to, and will not accidentally rotate away from that position.

As shown in FIG. 2, to capture the digital signals from the air, a pair of signal receiving conductive sheets 40 and 42 are fixed to the upper support surface of the substrate 30. Sheets 40 and 42 are spaced from each other along a diametric line 44 on the support surface, that passes through the axis of rotation 12. The central contact surface 34 of the second coaxial connector 32 is connected, e.g. by a lead wire and soldering 37 (see FIG. 3 as well), to one of the conductive sheets 40 at the upper surface of the substrate 30. The annular surface 36 of the second coaxial connector 30 is connected, e.g. by a lead wire and soldering 35, to the other conductive sheet 42 at the upper surface of the substrate 30.

Each conductive sheet 40 and 42, occupying at least 40% of a full semicircular area on one side of the diametric line 44 so that the conductive sheets together absorb digital signals from the air in a directional manner. The coverage can be up to almost 100% of the semicircular area on one side of the diametric line 44. The sheets can have the special shape shown in FIG. 2, to be described in detail later, or be simple semicircles on opposite sides of line 44 as shown in FIG. 5 where the total orthogonal dimensions X and Y of the sheets 40 and 42 are preferably in the range of 4 to 12 inches and preferably about 8 inches, or have any other shape. Other examples of the shapes of the sheets 40/42 and of the substrate 30 as well, can be found in the inventor's co-pending U.S. patent applications Ser. No. 29/324,238 filed Sep. 9, 2008, Ser. No. 29/324,033 filed Sep. 4, 2008, and Ser. No. 12/330,674 filed Dec. 9, 2008, which are all incorporated here by reference.

As shown in FIG. 1, the antenna according to the invention also includes a cover 50 of plastic, having a shallow concave recess at its under surface that is visible in FIG. 1, and that is fixed to the substrate 30, over the conductive sheets 40 and 42, the substrate and cover advantageously being circular, although other shapes such as oval or polygonal may be used. The plastic substrate 30 and the plastic cover 50 have spaced tabs and slots around their perimeter so that the two members are snapped together to form a unit that rotates on base 10.

As noted, each conductive sheet 40 and 42 can be generally semicircular in shape or have the special shape shown in FIG. 2. In the embodiment of FIG. 2, each conductive sheet 40 and 42 comprises a plurality of radially spaced, circumferentially extending arcs 45 having staggered ends defining circumferentially extending and interdigitated spaces and fingers 47 and 49. The inner circumferential base of each arc 45 for one sheet 40 or 42, merge in a one piece triangular base 43 for each sheet so that each sheet is a single conductive member for absorbing the airborne digital signals that are respectively carried to the core and braiding of the coaxial cable 20.

Base 10 includes a circular journal plate 52 of plastic that has a central hole 54. Journal plate 52 is attached, e.g. by four screws 56, to the top of the base 10 with connector 14 protruding upwardly in the center of hole 54. The hole 54 defines a circumferential rim spaced radially outwardly from the axis of rotation 12. The substrate 30 has a plurality, e.g. four, circumferentially equally spaced circumferential tabs 38 radially space from the axis of rotation and engaged inside the rim of hole 54 for rotationally mounting the substrate to the base. Tabs 38 are on a circle with a diameter about equal to that of hole 54 and each tab extends down from the lower surface of the substrate 30 and has a radially outwardly projecting step as shown in FIG. 3, that catches in hole 54 for rotatably mounting the substrate 30 to the plate 52 so that the substrate and cover cannot lift off the base. With the first and second coaxial connectors 14 and 32 mated by being plugged into each other, and tabs 38 engaged in hole 54, a strong and stable central rotational mounting for the substrate and cover is achieved.

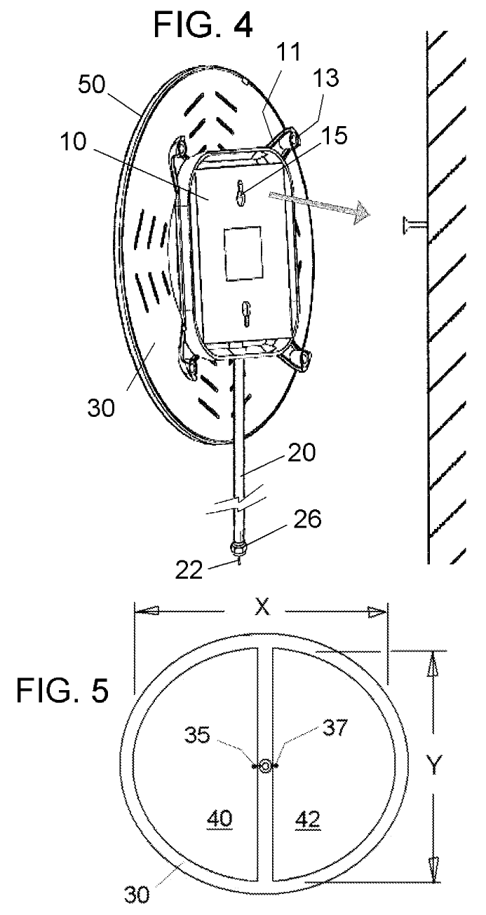

The base 10 including at least three and preferably four legs 11 each having a silicone pad 13 for high friction, movement resistant engagement of the base to a work surface. The base 30 also includes two spaced keyholes 15 in its bottom surface so that the antenna can be mounted, to a vertical surface like the wall, e.g. on a fastener 17, as shown in FIG. 4, near a TV set to which the antenna is connected by cable 20 and connector 26.

While specific embodiments of the invention have been shown and described in detail to illustrate the application of the principles of the invention, it will be understood that the invention may be embodied otherwise without departing from such principles.

What is claimed is:

1. An antenna for capturing digital signals from the air, comprising:
a base for establishing a fixed frame of reference, the base defining an axis of rotation;
a first coaxial connector connected to the base and having a central electrical and mechanical contact surface at the axis of rotation and an annular electrical and mechanical contact surface extending around the axis of rotation;
a coaxial cable having a core conductor electrically connected at one end to the central contact surface and an outer shielding conductor electrically connected at the one end to the annular contact surface;
a device connector electrically connected to an opposite end of the core and shielding conductors for connecting the coaxial cable to a device for receiving digital signals from the antenna;
a substrate mounted for rotation about the axis of rotation to the base, the substrate having a support surface extending outwardly from, and around the axis of rotation;
a second coaxial connector connected to the substrate and having a central electrical and mechanical contact surface at the axis of rotation and an annular electrical and mechanical contact surface extending around the axis of rotation, the central contact surfaces of the first and second connectors being engaged with each other for sliding electrical and mechanical contact, and the annular contact surfaces of the first and second connectors being engaged with each other for sliding electrical and mechanical contact, so that as the substrate rotates with respect to the base, digital signals pass from the second to the first connectors and to the coaxial cable conductors; and
a pair of signal receiving conductive sheets fixed to the support surface of the substrate, and spaced from each other along a diametric line on the support surface that passes through the axis of rotation, the central contact surface of the second coaxial connector being connected to one of the conductive sheets and the annular surface of the second coaxial connector being connected to the other conductive sheet, each conductive sheet occupying at least 40% of a full semicircular area on one side of the diametric line so that the conductive sheets together absorb digital signals from the air in a directional manner.

2. An antenna according to claim 1, wherein one of the central contact surfaces is a male surface and the other central contact surface is a female surface for slidably receiving the male central contact surface for rotation, and one of the annular contact surfaces is a male surface and the other annular contact surface is a female surface for slidably receive the male annular contact surface for rotation.

3. An antenna according to claim 1, wherein one of the central contact surfaces is a male surface and the other central contact surface is a female surface for slidably receiving the male central contact surface for rotation, and one of the annular contact surfaces is a male surface and the other annular contact surface is a female surface for slidably receive the male annular contact surface for rotation, the first connector being one of a male or female RCA connector and the second connector being the other of a male or female RCA connector.

4. An antenna according to claim 1, wherein the support surface faces away from the base and includes a cover fixed to the substrate over the conductive sheets.

5. An antenna according to claim 1, wherein the support surface faces away from the base and includes a cover fixed to the substrate over the conductive sheets, the substrate and cover being circular.

6. An antenna according to claim 1, wherein the support surface faces away from the base and includes a cover fixed to the substrate over the conductive sheets, the substrate and cover being circular, each conductive sheet being semicircular in shape.

7. An antenna according to claim 1, wherein the support surface faces away from the base and includes a cover fixed to the substrate over the conductive sheets, the substrate and cover being circular, each conductive sheet comprising a plurality of radially spaced, circumferentially extending arcs having staggered ends defining circumferentially extending and interdigitated spaces and fingers.

8. An antenna according to claim 1, wherein the support surface faces away from the base and includes a cover fixed to the substrate over the conductive sheets, the substrate and cover being circular, each conductive sheet comprising a plurality of radially spaced, circumferentially extending arcs having staggered ends defining circumferentially extending and interdigitated spaces and fingers of different circumferential lengths, longer interdigitated spaces and fingers of one conductive sheet being adjacent shorter interdigitated spaces and fingers of the other conductive sheet on opposite sides of the axis of rotation along the diametrical line.

9. An antenna according to claim 1, wherein the support surface faces away from the base and includes a cover fixed to the substrate over the conductive sheets, the substrate and cover being circular, the base having a circumferential rim radially space from the axis of rotation, and the substrate having a plurality of spaced circumferential tabs radially space from the axis of rotation and engaged with the rim for rotationally mounting the substrate to the base.

10. An antenna according to claim 1, wherein the support surface faces away from the base and includes a cover fixed to the substrate over the conductive sheets, the substrate and cover being circular, the base having a circumferential rim radially space from the axis of rotation, and the substrate having a plurality of spaced circumferential tabs radially space from the axis of rotation and engaged with the rim for rotationally mounting the substrate to the base, one of the central contact surfaces being a male surface and the other central contact surface being a female surface for slidably receiving the male central contact surface for rotation, and one of the annular contact surfaces being a male surface and the other annular contact surface being a female surface for slidably receive the male annular contact surface for rotation, the engagement between the first and second coaxial connectors forming a central rotational mounting for the substrate.

11. An antenna according to claim 1, wherein the support surface faces away from the base and includes a cover fixed to the substrate over the conductive sheets, the substrate and cover being circular, the base having a circumferential rim radially space from the axis of rotation, and the substrate having a plurality of spaced circumferential tabs radially space from the axis of rotation and engaged with the rim for rotationally mounting the substrate to the base, the first and second coaxial connectors each being one of mated male and female RCA connector for forming a central rotational mounting for the substrate.

12. An antenna according to claim 1, wherein the support surface faces away from the base and includes a cover fixed to the substrate over the conductive sheets, the substrate and cover being circular, each conductive sheet being semicircular in shape, the base having a circumferential rim radially space from the axis of rotation, and the substrate having a plurality of spaced circumferential tabs radially space from the axis of rotation and engaged with the rim for rotationally mounting the substrate to the base, the first and second coaxial connectors each being one of mated male and female RCA connector for forming a central rotational mounting for the substrate,

13. An antenna according to claim 1, wherein the support surface faces away from the base and includes a cover fixed to the substrate over the conductive sheets, the substrate and cover being circular, each conductive sheet comprising a plurality of radially spaced, circumferentially extending arcs having staggered ends defining circumferentially extending and interdigitated spaces and fingers, the base having a circumferential rim radially space from the axis of rotation, and the substrate having a plurality of spaced circumferential tabs radially space from the axis of rotation and engaged with the rim for rotationally mounting the substrate to the base, the first and second coaxial connectors each being one of mated male and female RCA connector for forming a central rotational mounting for the substrate.

14. An antenna according to claim 1, wherein the support surface faces away from the base and includes a cover fixed to the substrate over the conductive sheets, the substrate and cover being circular, the base including at least three legs each having a silicone pad for high friction, movement resistant engagement of the base to a work surface.

15. An antenna according to claim 1, wherein the support surface faces away from the base and includes a cover fixed to the substrate over the conductive sheets, the substrate and cover being circular, the base including at least three legs each having a high friction pad for high friction, movement resistant engagement of the base to a work surface.
